(19) United States
(12) Patent Application Publication
(10) Pub. No.: US 2022/0111749 A1
(43) Pub. Date: Apr. 14, 2022

(54) System and Method for Providing Backup Power

(71) Applicant: Babatunde Adegbile, Dayton, OH (US)

(72) Inventor: Babatunde Adegbile, Dayton, OH (US)

(21) Appl. No.: 17/070,641

(22) Filed: Oct. 14, 2020

(51) Int. Cl. B60L 53/53; B60L 53/16; B60L 53/18; B60L 53/63; B60Q 1/30; B60Q 1/26; H02J 9/06

(52) U.S. Cl. CPC B60L 53/53; B60L 53/16; B60L 53/18; B60G 17/00; B60Q 1/305; B60Q 1/2692; H02J 9/068; B60L 53/63

(57) ABSTRACT

A system includes an energy storage device for increasing the mileage of an electric vehicle. A power bank provides backup power to the electric vehicle, the power bank including one or more batteries connected in series or parallel. A housing section is arranged in the energy storage device for securing the power bank and a plurality of tires is configured to bestow mobility to the energy storage device. A towing or tethering mechanism is operable for engaging the energy storage device to the electric vehicle. A cable or power cord with power adapter or plug is configured to electrically couple the electric vehicle to the energy storage device. A power switch and/or controller is configured to switch to the power bank once the power switch detects battery in the electric vehicle is depleted. In the case of two or more power bank systems, a power switch and/or controller is able to select between which power bank within an ESD has available charge and which one has been fully depleted.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a battery recharging. More particularly, certain embodiments of the invention relate to electric vehicle battery recharging.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

As crude oil becomes scarce, alternative sources of energy for transportation besides fuel have become more common. One typical solution for replacing fuel-based vehicles is electric vehicles (EVs). EVs use an electric motor propulsion and are usually powered by batteries. One common issue for EVs may be their limited range, which is also common in fuel-based vehicles. However because generally, EV battery recharging stations are far fewer than gasoline stations, it leaves consumers with anxiety about being left stranded. Furthermore, fully recharging EV batteries typically take significantly longer than it takes fuel-based vehicles to fill their tanks with gas. While it may work for most people to charge their EV at the end of the day, while they sleep, this may be an issue for people who drive more than the average individual, and also for people who need to travel long distances. Stopping to recharge batteries during a long trip may significantly delay the trip, and the trip could take significantly longer if a less common supercharging station is not nearby.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side view of an exemplary Energy Storage Device (ESD) in a tether, in accordance with an embodiment of the present invention;

FIG. 2 illustrates a side view of an exemplary setup for two ESDs in a tether or daisy-chain, in accordance with an embodiment of the present invention; and

FIG. 3A-3E illustrates numerous methods in which an ESD may be attached to a host vehicle, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003) Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hollinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112 , and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that like the term ‘about,’ the term ‘substantially’ is a descriptive term commonly used in patent claims to ‘avoid’ a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction with, some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performance by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware--for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112 (6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiment of the present invention may provide an Energy Storage Device (ESD) as an improved means of keeping an EV's battery charged. The ESDs may be affixed on at least one or more wheels, which may be attached or towed as tailgate or trailer, which may then be attached to the back of an EV. Some embodiments may furthermore provide a network of ESDs available for a consumer to pick up and drop off at a later location. The ESDs may provide an instantaneous power available for EVs. This arrangement may enable EVs to significantly increase their mileage range. The ESDs may also help eliminate lengthy waiting periods or delays during recharging and eliminate the time out of service for EVs and other devices due to the current inefficient methods of recharging.

The present invention will now be described in detail with reference to embodiments thereof as illustrated in the accompanying drawings.

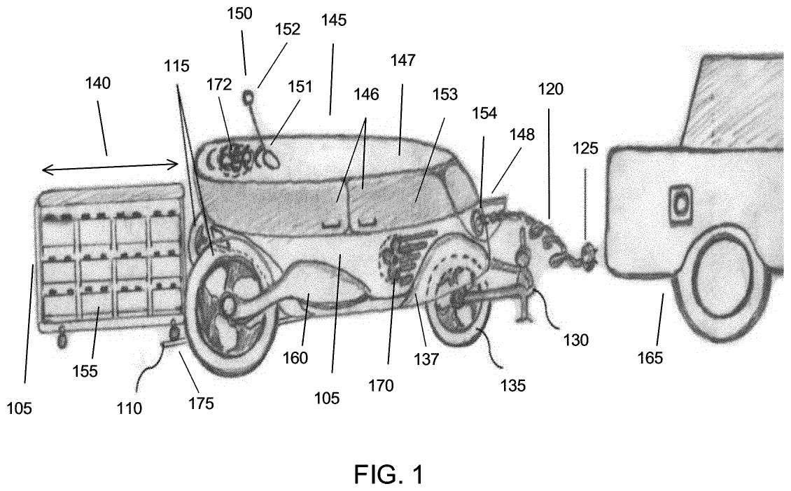

FIG. 1 is an illustration of an exemplary system showing a side view of an Energy Storage Device (ESD) 145 in a tether, in accordance with an embodiment of the present invention. In the present embodiment shown, Energy Storage Device (ESD) 145 in the center may be mobile, and may be tethered to an electric vehicle (EV) 165 on the right, with a customized retractable trolley system 140 loaded with Power Bank (PB) 105 to its left. The ESD may comprise of two (2) rear-end tires 115, a front tire 135, a network component 150, an in-blowing cooling fan 170, a towing/tethering mechanism 130, retractable extension arms 160, an out-blowing cooling fan 172, a PB housing 147, horizontal-mount access handles 152, tinted shields 153, an EV outlet 245, and a swivel-open protective front door grille 148. ESD 145 may also contain a set of Power Bank (PB) 105. The Power Bank (PB) may be backup/additional power placed on a customized retractable trolley system 140, so as to facilitate easy reconnect/disconnect during a swap-out. Power Bank (PB) system 105, may comprise of a network of smaller PBs 155, such as but not limited to batteries, which may be connected in series, parallel, or a combination of both to maximize its potential applications. The ESD may be configured to allow various numbers of smaller PBs 155 placed vertically or horizontally into spaces within PB housing 147 which could be expanded, reduced, customized, or upgraded as needed.

In some embodiments, front tire 135 may be height adjustable within its wheel-well 137 via an actuating strut and/or solenoid system. The front tire preferably may be maintenance-free type, does not require air inflation, durable, reliable, and safe. In some embodiments, front tire 135 may include one (1) or two (2) height adjustable tires. Retractable extension arms 160 may be mounted to rear-end tires 115. The tires are mainly to provide mobility to the ESD. Retractable arms 160 may have the capability to adjust by extending proximally or distally to facilitate stability of a ride during towing/tethering. The retractable arms may further have the capability to extend vertically such that the ESD may be lifted up where both rear-end tires are out and have a higher height than the wheel-wells. Or, dropped where both rear-end tires are in-ward, have a lower height than the wheel-wells, and are just under the wheel-wells. In-blowing cooling fan 170, may foster ventilation within the ESD. Towing/Tethering mechanism 130 may be adjustable and also easily may be removed and/or replaced via its quick mount and dis-mount mechanism. Out-blowing cooling fan 170 may foster ventilation within the ESD. PB housing 147 is configured to secure a power bank. Horizontal-mount access handles 146 are configured to enable access to stored PBs.

EV outlet 154 may accept a universal cable and/or power cord 120 and the universal power adapter and/or plug 125, in which the power cable and/or plug both may be detached, extended, exchanged, or adapted to various sizes or types as deemed necessary. The EV outlet couples electric vehicle (EV) 165 to the power bank (PB) in the ESD. The power bank (PB) in the ESD and retractable trolley system 140 may provide backup power to be used by the electric vehicle. In this manner, once the EV power bank is depleted, a power source switch may detect the depleted power bank and automatically switches to the ESD power bank and/or retractable trolley system power bank. The power source switch may include a programmable controller that may automatically determine which power bank is depleted, energized, and which bank to use. In other embodiments, the ESD power bank or retractable trolley system power bank may provide main power to be used by the electric vehicle.

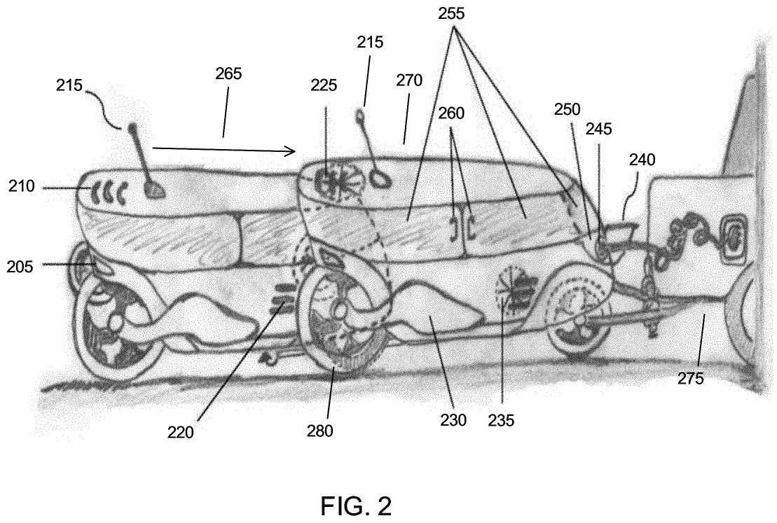

Swivel-open protective front door grille 240 (FIG. 2) may house a headlight, headlamp, work-lamp, other light-emitting diode (LED) type lighting, or various other safety features amongst others.

In one embodiment, network component 150 may be capable of a series of functions such as an antenna, radio, internet, WIFI, blue-tooth, GPS, and remote operation. Through these network components a user may interface with the ESD system on a network capable device such as a smartphone or a vehicle's dashboard. Network antenna component 150, has at least one or more powerful LEDs 152 affixed at its top, which has the function to stay on solid, flash, and/or emit sounds, so as to alert, warn, or remind its driver, other drivers, and other surrounding individuals, of the ESD cargo behind. The antenna with an LED affixed to its top, may retract or telescope out far or high enough, so that the driver of the EV or vehicle, along with other surrounding drivers and/or individuals, may clearly visualize the antenna at all times as a reminder of the ESD as cargo. For instance, the LED may be synchronized with the braking system, so that when one decelerates, it stays on solid red, and then either turns off afterwards or change to a different solid color.

In one embodiment, Power Bank (PB) 105 may be backup/additional power placed on a customized retractable trolley system 140, so as to facilitate easy reconnect/disconnect during a swap-out. Power Bank (PB) system 105, may comprise of a network of smaller PBs 155, such as but not limited to batteries, which may be connected in series, parallel, or a combination of both to maximize its potential applications. The ESDs may be configured to allow various numbers of smaller PBs 155 placed vertically or horizontally into spaces within PB housing 147 which could be expanded, reduced, customized, or upgraded as needed. PB 105 may be mounted on customized retractable trolley system 140, may allow for a simplified removal from and/or insertion of the PB into the ESD for a swap-out. In one scenario, the end-user may arrive at a charging station and the PB may be quickly disconnected via quick disconnect terminals 175, wheeled-out, and immediately replaced with another PB 105 that may have been re-energized earlier and ready to be swapped-out for a de-energized PB.

In some embodiments, trolley system 140 may be motorized so as to alleviate weightiness of PB(s) and facilitate its removal irrespective of whether the user is an elderly, small-statured, or frail individual. Additionally, specialized forklifts may be available at the filling or charging stations, which may facilitate removal of the weighty PB banks either by the end-user, or by the attendees at the charging station. Concerning ESDs, which are placed in locations whereby the end-user (end-user in this case refers to the EV or vehicle operator for instance), may not necessarily easily get to the ESDs, such as with ESDs placed on the roof or type R, or ESDs placed in the undercarriage of a truck or big-rig or type U, as explained in the ensuing paragraphs, for safety reasons, attendees may be required to service the ESDs in such cases, as proper knowledge and operation of heavy-duty equipment such as forklifts would be necessary. Swapping-out depleted PB(s) from an ESD, may be quicker than having to pump gas, or having to sit around and wait for an EV to recharge using the current approach utilized at charging or supercharger stations. The ESDs may be obtained by means such as but not limited to purchasing, renting, or leasing, and may vary in size, type, design, and customization. Again, in roughly the same amount of time it would take to swap-out a PB 140 from an ESD 145, there is the option to swap-out entire ESD 145. PBs 140 may be configured to be fitted to any style, shape, size, or capacity ESD. An ESD may also be replenished simply by draining its de-energized battery liquid/substance and refilling with reenergized battery liquid or substance, which is synonymous to gassing-up a gas-operated or diesel-operated vehicle. A rear access retractable platform 110 may provide footing that may be stood upon during servicing or swapping.

With reference now to both FIGS. 1 and 2, the rear access retractable platform may be activated manually or automatically and also may attach to the underside of the second ESD during and/or when in a tether mode as depicted in FIG. 2. To facilitate easy access to a rear onboard screen/remote control system(s) 151, rear access retractable platform 110 may also double as footing that may be stood upon by an individual. With reference now to both FIGS. 1 and 2, two rear-end tires 115 may be mounted in 230. These tires may be a maintenance-free type, which may not require air inflation but are very reliable and safe. A universal cable and/or power cord 120, may be removable, extendable, exchanged, or adapted to various sizes or types of cables or cords as deemed necessary so as to be compatible with currently known types of EV Supply Equipment such as types 1 or J-plugs, types 2, types 3 such as CHAdeMO fast chargers, SAE combo (CCS), and Tesla super chargers, among prospective others. A plug portion 125 of the cable or cord may be removable and may be extended, exchanged, or adapted to various sizes or types of adapter, cables, connectors, sockets, chargers, leads, or plugs as aforementioned, to facilitate connection to various types of EVs or any other system that may need additional power.

In some embodiments, to facilitate connection and/or interaction between the ESD and a host vehicle such as an EV, a plurality of prospective solutions may encompass, 1) updating the main onboard OEM software and/or hardware; 2) appending a software or an app such as via a special wire harness, or via the OBD-II device using the OBD-II communication port of an EV if available, which can communicate with the main onboard computer(s) of an EV, either to patch the OEM software or build on the OEM software; 3) hardwire a compatible harness/communication/bridge/link between EV and ESD; and 4) utilize numerous wireless communication mediums such as WIFI, Bluetooth, satellite, radio frequencies, 4G network, and the like.

In other embodiments, some EVs may disable the drive function while charging. As such, one way to circumvent this is to control, bypass, or override such function. For instance, when an ESD is connected to an EV, the ESD becomes the primary and/or priority power source to first be depleted. Hence, in one embodiment, a controller could control/disable the EV power supply (rendering it to be in either an off or ready to charge mode for instance), whereby, the ESD is then enabled as the main power source. This may call for at least, one separate dedicated power supply harness, (aside from the charge-back harness which replenishes the on-board EV factory bank), which would transfer power whether directly or indirectly, to the electric motor(s) within the EV or a host vehicle. Should the ESD become depleted, the EV factory bank may be re-enabled to resume power as the main source of power supply to the EV. Additionally, while the ESD is connected to the EV as the primary power source, the ESD could also charge-back or replenish the EV factory bank simultaneously, such as via a charging harness that is connected between the ESD and the EV for instance. It is noteworthy that, as with any harnesses such as trailer/hitch harnesses or custom loud speaker wire harnesses, the ESD/EV wire harnesses/bridge/link/communication, could be custom-wired to suit a plurality of applications as deemed necessary by those with ordinary skill in the arts.

In additional embodiments, aside from EVs, the power output from the ESD could be used to supplement power for systems, including but not limited to, homes, camp sites, remote villages, or remote areas. A towing/tethering mechanism 130 may be adjustable and also easily may be removed and/or replaced via its quick mount and dismount mechanism. For example, without limitation, a basic towing mechanism or system may comprise one or more of the following which facilitate towing: a trailer hitch, ball mount, trailer ball, hitch pin/safety pin, trailer coupler, safety chains, trailer wiring harness/harnesses, tow vehicle (the EV for instance), and a trailer (the ESD itself in this case).

A front tire 135, which the height also may be adjustable as needed within its wheel-well via an actuating strut and/or solenoid system; the tire preferably may be the maintenance-free type, which does not require air inflation, but may be very durable, reliable, and safe. An in-blowing cooling fan170, may foster ventilation within the ESD. Aside from the air-cooling system, liquid cooling may also be necessary either as supplemental cooling system or as an upgrade. A network component 150 may be capable of a series of functions such as, but not limited to, an antenna, radio, internet, WIFI, blue-tooth, GPS, and/or remote operation. Through these network components, a user may interface with the ESD system on a network capable device such as a smartphone or a vehicle's dashboard.

The ESD may be made from light weight, fire-proof, and durable materials, including but not limited to, a body constructed using fiber-glass-type material, carbon-fiber-type material, plastic, titanium, and/or steel reinforcements as deemed necessary. This may curtail a possible scenario whereby the ESD may be struck by debris, thus causing one or more of its PBs to become damaged or to ignite. As the body of a vehicle serves as number one protection to its contents and/or passengers, so does the body of the ESD may serve as a tough, durable, fire-proof, and protective encasement for the PBs within the ESD. In one embodiment, the ESD may utilize techniques to reduce the overall weightiness of the PBs and ESDs via means not to be limited to, hydraulics, air-springs, air-compressor(s) and/or turbines to levitate the ESD.

In yet another embodiment, concerning weightiness, the ESD may utilize a pre-set portion of its own PBs, to self-propel the entire ESD. When in tether mode whereby the ESD wheel or wheels make contact with the ground, the ESD may utilize its in-built self-propel mechanism as a fool-proof solution to its weightiness. This is synonymous to anything that is self-propelled, not limited to a self-propelled mower. The self-propelled mechanism may sense and predict the rate of accelerations and decelerations of the host EV or other vehicle(s), and may automatically adjust its speed to match and/or coincide with the host vehicle(s). Additionally, the ESD may also receive data with respect to acceleration and deceleration via a bridge/communication harness between the ESD and the EV or host vehicle. It is noteworthy that in self-propelled mode, a portion of the ESD PB is dedicated to the self-propel mechanism so as to mitigate weightiness of the ESD. The following teachings apply.

In one embodiment, there may be a dedicated portion of the bank of the ESD whereby the dedicated portion is physically dedicated to the self-propel mechanism; in another embodiment, the dedicated portion is numerically dedicated as-in a percentage of the entire power bank. In either case, the dedicated power bank(s) should be excluded in the advertised total range of the ESD. For instance, if the entire power bank of an ESD can add roughly 500 miles of range to an EV, and about 10% has been determined or dedicated to propel the ESD until depletion, so as to mitigate its weightiness, then the total rated useful range of the ESD is advertised as, or figured to be approximately 450 mile-range of additional power. This is assuming that the power bank(s) within the ESD is capable of depleting more or less 100% of its rated power. In a more practical case whereby the ESD may only deplete up to about 80% of its power for instance prior to requiring re-energization, the same 500 miles rating would be down to 400 miles, and if one figures-in the 10% required for the self-propel mechanism(s) for instance, the ESD would be rated at between 350 and 360 miles of useful additional power. By design, this also ensures that when the ESD is considered depleted and no-longer able to provide adequate power to an EV or other host vehicle, the ESD still has enough dedicated power to self-propel to the nearest filling or charging station, thus eliminating the effects of its weightiness as a drag on the factory EV bank(s). Accoutrements such as solar power or photovoltaic cells among other green or renewable energy may be added to the ESD so as to re-energize or increase the range of not only the bank(s) that are dedicated to the self-propelled mechanism, but also that of the main ESD bank(s), both during transit, and when idle. Additionally, decelerations may be harnessed and used to re-energize the ESD. The aforementioned are merely possible scenarios, which are not meant to limit the ESD in any way, shape, or form, and any necessary modifications would be apparent to individuals who are skilled in the arts, without necessarily straying away from the heart of the invention.

FIG. 2 illustrates a side view of an exemplary setup for two Energy Storage Devices (ESD) in a tether, in accordance with an embodiment of the present invention. For the two ESDs in a tether/daisy-chain, a right-most main ESD 270 may be tethered (or towed) onto an EV 275 on the right, and a furthermost ESD 265 on the extreme left may be tethered onto or into a main ESD 270 to the right. The ESDs that are tethered may be depleted in any order using power source switches. A possible order could be, but is not limited to, if two ESDs are daisy-chained the furthest ESD (number two) may deplete first followed by the closest ESD (number one) to the EV. Another possible order could be, but is not limited to, if four ESDs are daisy-chained the furthest fourth ESD may be depleted first followed by numbers, three, two, and finally, the closest ESD (number one) to the EV may deplete last. The ESDs may be designed such that one ESD may be placed inside of another ESD in a tether of two or more ESDs, where a front wheel of the ESD that may be behind, may align with rear wheels of the ESD in front. This may create a more stable tether of ESDs where all tethered ESDs may act as a single stabilized and secured ESD during towing, tethering, or transportation.

In another embodiment, during a tether, with one ESD or TES′ being stacked atop another, the top-most TES′ may first deplete, followed by the next top-most TES′, up until the bottom-most TES′, followed by the EV's factory bank. Both the distal to proximal depletion, and the top-most to bottom-most depletion, facilitate a speedy service process at the service station, whereby the outer-most ESD or the top-most ESD can easily be accessed for servicing, negating the need to untether or unstack a bunch of ESDs just to get to a particular ESD that may have been depleted.

In certain circumstances the ESD may be equipped to allow a tow option at its rear for regular tow of other items, a tow option at the top rear area to accommodate 5th wheels and to be equipped with an extension cabling system such that the ESD maintains system, power, and data connectivity among others, to the EV, should there be a larger item being towed between the ESD and the EV. In other words, where applicable and/or permitted, the ESD may be tethered to a larger tow item which the item may then be tethered directly to the EV. The ESD may have rear tail-light markers 205, brake lights, or other light-emitting diode (LED) type lighting and safety features. Furthermore, as a result of the anti-weightiness self-propel feature, the aforementioned network component 150 doubles as an additional safety feature. Whenever the ESD is tethered or towed so that its wheel or wheels touch the ground, the network antenna component 150, has at least one or more powerful LED 215 affixed at its top, which has the function to stay on solid, flash, or emit sounds, so as to alert, warn, or remind its driver, other drivers, and other surrounding individuals, of the ESD cargo behind. The antenna with a LED affixed to its top, may retract or telescope out far or high enough, so that the driver of the EV or vehicle, along with other surrounding drivers and/or individuals, can clearly visualize the antenna at all times as a reminder of the ESD as cargo; for instance, the LED may be synchronized with the braking system, so that when one decelerates, it stays on solid red, and then either turns off afterwards or change to a different solid color. Additionally, the driver may receive status updates in the form of emitting sounds or voice warnings within the EV or other host vehicle, thus alerting or reminding the driver of the ESD cargo behind. Furthermore, it is common for late model vehicles to incorporate a rear-view camera as a standard option. In which case, the camera could double as a way to safely monitor the ESD/cargo behind. Vehicles without this option can always be outfitted with a rear-view camera for monitoring the ESD/cargo as an added safety option. Top/roof air-out-letting vents 210, may have a raised and curved canopy above it, so as to prevent entrance of rain and/or moisture. These vents may help dissipate heat more efficiently and improve ventilation. Alternatively, the top/roof vents may be located in any other area aside from the top of the roof in order to mitigate the chances that rain or moisture may end-up inside, which could be detrimental to both the ESD and the battery cells; a simple solution around this would be to have an intake/outtake conduit whereby warmer/hotter air is evacuated from within the ESD in such areas that tend to be hot such as near the top of roof, and the the warmer/hotter air is evacuated via the conduit, which the conduit is eventually vented-out to the surroundings via vents located on the sides, or near the bottom/base of the ESD. The network component may be capable of a series of functions such as an antenna, radio, internet, WIFI, blue-tooth, GPS, and other remote operations. Through these network components a user such as man, machine, humanoid, or other, may interface with the ESD system on a network capable device such as a smartphone or a vehicle's dashboard.

With reference now to both FIGS. 1 and 2, retractable extension arms 230 may be mounted to the rear-end tires 280. These retractable arms may have the capability to adjust by extending proximally or distally in other to facilitate stability of ride during towing/tethering. With reference now to both FIGS. 1 and 2, these arms may furthermore have the capability to extend vertically such that the ESD may be lifted up as depicted in FIG. 1 where both rear-end wheels are out and have a higher height than the wheel-wells, or dropped as depicted in FIG. 2 where both rear-end wheels are in-ward, have a lower height than the wheel-wells, and are just under the wheel-wells. Air-in-letting vents 220 may be designed for cooler air-intake to improve ventilation. An out-blowing cooling fan 225 may foster ventilation within the ESD. Aside from an air-cooled system, liquid cooling system(s), among a plethora of cooling options, may also be utilized either as supplemental cooling system or as an upgrade. A swivel-open protective front door grille 240 may house a headlight/headlamp/work-lamp/other light-emitting diode (LED) type lighting, or various other safety features amongst others. With reference to both FIGS. 1 and 2, an EV outlet 245 may accept the universal cable and/or power cord as depicted in 120, and the universal power adapter and/or plug as depicted in 125, in which the power cable and/or plug both may be detached, extended, exchanged, or adapted to various sizes or types as deemed necessary. An area behind the swivel-open protective front door grille 250 may house a series of electronic ports such as USB, adapters, connectors, various common DC and VAC outlet types, and the EV outlet. A tinted shield 255 may comprise a protective thermal reduction shield, which may incorporate various accoutrements as necessary. With reference to both FIGS. 1 and 2, decorative quick access handles 260 may be a vertical mount in FIG. 2, but a horizontal-style mount in FIG. 1.

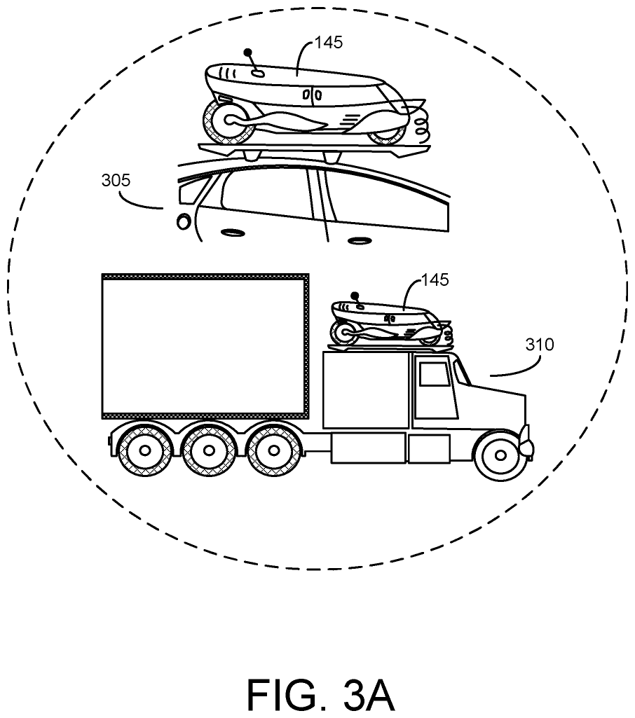

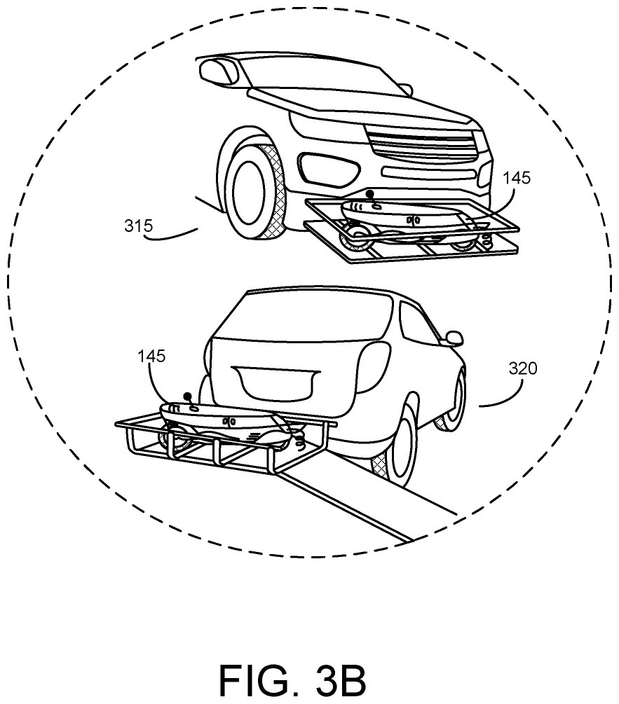

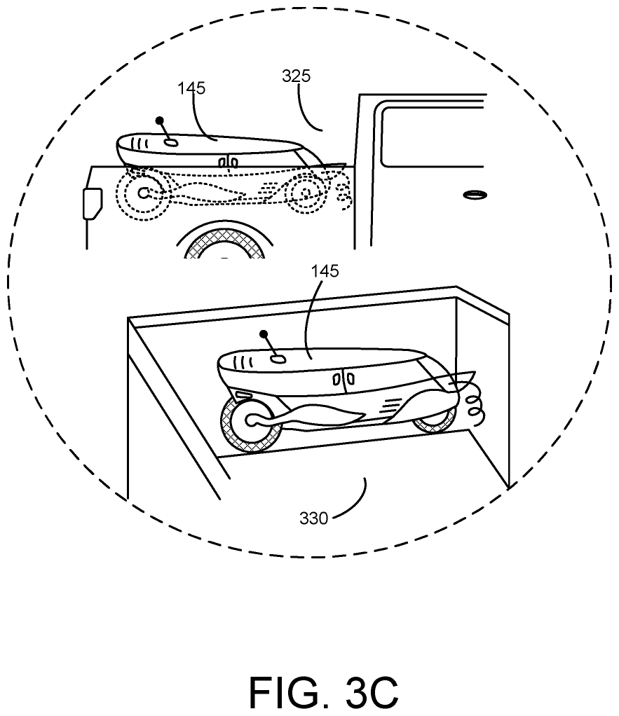

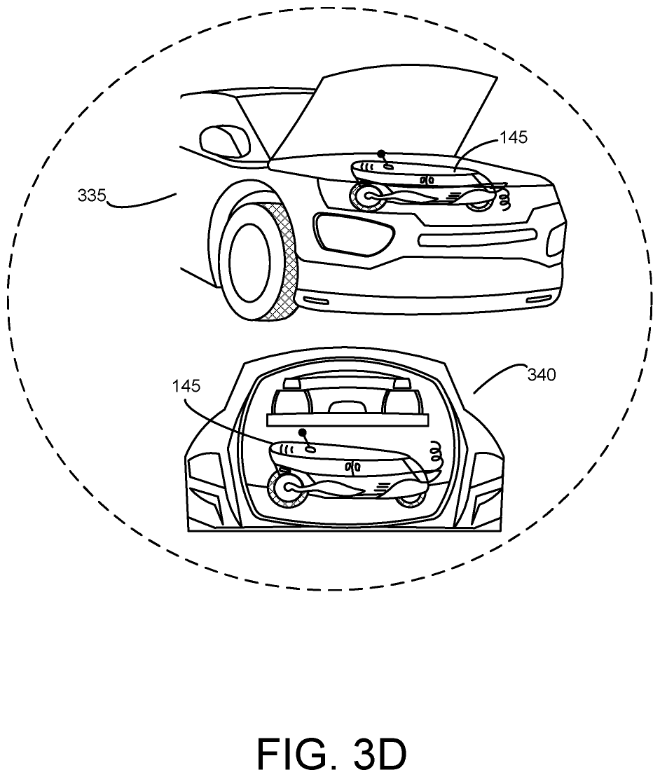

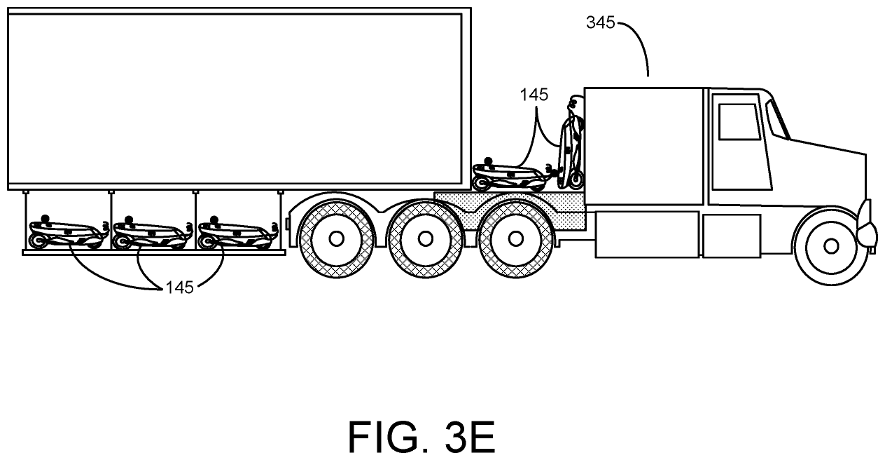

FIG. 3A-3E illustrates the numerous methods in which the ESD 145 could be attached to a host vehicle such as an EV, in accordance with an embodiment of the present invention. In the present embodiment shown, the numerous methods in which the ESD could be attached to a host vehicle such as an EV may include, but not limited to, namely, types R, F, C, and U attachments. The aforementioned methods for attachment would depend on the specific application, which may encompass, but is not limited to, being attached/housed in the rear, front, roof-top cargo areas, general cargo areas, trunk or booth, hood or bonnet, behind seat cargo areas, underneath seat cargo areas, trailer bed cargo areas, between a trailer and the load/hitch, or under-carriage areas of an EV or a host vehicle.

In one embodiment, referring to FIG. 3A, ESD 145 could be placed atop an EV externally on the roof-top cargo area, type R, as illustrated in 305 and 310.

In another embodiment, referring to FIG. 3B, ESD 145 could be attached from the front or rear end of a host EV, type F, as illustrated in 315 and 320, which is synonymous to how a bike-rack attaches from either the front end or back end of a vehicle, with or without the ESD wheel(s) in contact with the ground.

In another embodiment, referring to FIG. 3C and FIG. 3D, ESD 145 could be placed in the general cargo areas, types C as illustrated in 325, 330, 335, and 340, such as in the trunk or booth, the hood or bonnet, behind seat cargo areas, or underneath seat cargo areas.

In yet another embodiment, referring to FIG. 3E, ESD 145 could be attached to or placed in the under-carriage of a truck or big-rig, type U, as illustrated in 345, or yet in another embodiment, the ESD could be placed on the trailer bed cargo area between the trailer and the load/hitch . The one consideration would be to allow for at least six feet of clearance between the ESD and the hitch/load in the event of a jackknife or in the event that the trailer/load is on an uneven hill, which might cause the load to lean towards the ESD.

Additionally, concerning the U type attachment 345 as enumerated above, although the ESD(s) may be housed in the undercarriage area of a big-rig or 18-wheeler for instance, the ESD(s) may also be tethered, towed, or engaged from the undercarriage location. This serves to save space and circumvent the possibility of exceeding legal tow-lengths in certain regions by allowing the ESD(s) to be tethered, towed, or engaged from the undercarriage location, rather than to be appended to the total length of the trailer. With the ESD(s) in the undercarriage location, when the self-propel mechanism is engaged, this allows the ESD(s) to match both acceleration and deceleration speeds of the host trailer/big-rig, virtually eliminating weightiness of ESD or cumulative weightiness of ESDs upon the big-rig. However, if the ESD(s) where ordinarily stored in the undercarriage area, whether or not activated to supply power, as long as the wheels of the ESD(s) do not make contact with the ground, the self-propel mechanism would not be engaged, and as such, the big-rig bears the full weight of the ESD(s).

Furthermore, for certain vehicles, such as SUVs, trucks, truck beds, and trailers, just to name a few, considering that the ESD may have retractable/telescoping wheels that can be engaged or disengaged. With the wheels in disengaged, retracted, or hide-away mode, the ESD(s) may be stacked, without consequence as to the cumulative weight of all of the stacked ESDs, upon the wheel(s)/tire(s) of one or more of the stacked ESDs, thus allowing for a safe and steady way to stack said ESDs. In essence, this space-saving stacking of ESDs may allow for certain vehicles with deeper, higher, or taller carriage compartments, such as with, but not limited to, SUVs, trucks, and trailers, just to name a few, to carry additional ESDs, while also allowing for safe operation of host vehicles.

In alternative embodiments, with regards to the method of replenishing the power bank with reenergized battery fluid, the aforementioned idea is synonymous to gassing-up a gas-operated or diesel-operated vehicle. But in this instance, with respect to EVs and other electrical systems. A specialized pump would drain the depleted power bank, and although the same pump may also then apply reenergized battery fluid, it is likely and/or more practical to have a separate/dedicated filling pump, which will reenergize power bank. As such, a dual pump system may be provided, with at least a drainage pump or a series of drainage pumps, being dedicated to draining battery fluid from the power bank and the other pump or series of pumps, being dedicated to filling the power bank with reenergized battery fluid. For ease of use, as synonymous to draining oil from a gas-operated vehicle, at least one drainage-valve may be incorporated to facilitate an end-user drainage of depleted battery fluid from the power bank. And, at least a filling pump may then be utilized to fill-up the power bank with reenergized battery fluid. Swapping of battery fluid would be an alternative solution to the swapping of an entire ESD. Furthermore, the aforesaid not only address the issue of range, but also offer feasible or practical solutions against long waits at charging stations.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6).

It is noted that according to USA law, all claims must be set forth as a coherent, cooperating set of limitations that work in functional combination to achieve a useful result as a whole. Accordingly, for any claim having functional limitations interpreted under 35 USC § 112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112 (6) is to be interpreted as the function of the local system receiving the remotely generated information required by a locally implemented claim limitation, wherein the structures and or steps which enable, and breath life into the expression of such functions claimed under 35 USC § 112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112 (6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112 (6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing battery recharging according to the present invention will be apparent to those skilled in the art. Various aspects of the invention have been above described by way of illustration, and the specific embodiments disclosed are not intended to limit the invention to the particular forms disclosed. The particular implementation of the battery recharging may vary depending upon the particular context or application. By way of example, and not limitation, the battery recharging described in the foregoing were principally directed to electric vehicle battery recharging implementations; however, similar techniques may instead be applied to recharging electric power for any means of transportation using electricity as at least one of its power sources such as with semi-trucks, buses, bikes, skateboards, scooters, trains, airplanes, and ships, just to name a few of a plurality of scenarios, which implementation(s) of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
an energy storage device, said energy storage device is configured to increase a mileage of a vehicle;
a power bank, wherein said power bank is configured to provide backup power to said electric vehicle to increase said mileage of said electric vehicle;
said power bank comprises one or more batteries connected in series or parallel;
a housing section arranged in said energy storage device, said housing section is configured to generally secure said power bank in said energy storage device;
a plurality of tires configured to bestow mobility to said energy storage device;
a towing or tethering mechanism or system that is configured to be operable for engaging said energy storage device to the electric vehicle;
a cable or power cord with power adapter or plug that is configured to electrically couple said electric vehicle to said energy storage device;
an outlet that is configured to accept said power cord; and
a power switch, said power switch is configured to switch to said power bank once said power switch detects battery in the electric vehicle is depleted.

2. The system of claim 1, further comprising a retractable trolley system that is configured to carry the power bank, said retractable trolley system is operable for easy reconnecting or disconnecting.

3. The system of claim 2, further comprising a programmable controller coupled to said power switch, wherein said programmable controller is configured to automatically determine which power bank is depleted, energized, and which bank to use once battery in the electric vehicle is depleted.

4. The system of claim 3, further comprising an access handle implement, said access handle implement is configured to enable access to said power bank for replacement or maintenance.

5. The system of claim 4, further comprising a network component, said network component comprises an antenna and an LED affixed at a top of said antenna.

6. The system of claim 5, wherein said LED is configured to at least one of, stay on solid and flash, so as to alert, warn, or remind the electric vehicle driver, other drivers, and other surrounding individuals, of the energy storage device, which is tethered or towed behind.

7. The system of claim 6, wherein said antenna at least one of, retract and telescope out so that the electric vehicle driver, other drivers, and other surrounding individuals, can visualize the towed energy storage device at all times.

8. The system of claim 4, in which said plurality of tires comprises a front tire and two rear tires.

9. The system of claim 8, wherein said plurality of tires are height adjustable within its wheel-well via an actuating strut or solenoid system.

10. The system of claim 9, further comprising retractable arms, each mounted to said plurality of tires, wherein said retractable arms are configured to adjust by extending proximally or distally to facilitate stability of a ride during towing or tethering.

11. The system of claim 1, further comprising a second energy storage device operable for increasing said mileage of said electric vehicle.

12. The system of claim 11, wherein said second energy storage device comprises a second power bank, wherein said second power bank is configured to provide a second backup power to said electric vehicle to increase said mileage of said electric vehicle.

13. The system of claim 12, further comprising a programmable controller coupled to said power switch, wherein said programmable controller is configured to automatically determine which power bank is depleted, energized, and which bank to use.

14. The system of claim 13, further comprising a rear access retractable platform that is configured to provide footing that is stood upon during servicing or swapping.

15. The system of claim 14, wherein said servicing or swapping comprises the step of draining a de-energized battery liquid/substance and refilling with reenergized battery liquid or substance.

16. A system comprising:
means for increasing a mileage of an electric vehicle;
means for providing a backup power to said electric vehicle to increase said mileage of said electric vehicle;
means for securing said backup power providing means in said mileage increasing means;
means for bestowing mobility to said energy storage device;
means for engaging said mileage increasing means to the electric vehicle for towing;
means for electrically coupling said electric vehicle to said mileage increasing means;
means for accepting said electrical coupling means;
means for switching said backup power providing means once said backup power switching means detects battery in the electric vehicle is depleted; and
means for automatically determining which power bank is depleted, energized, and which bank to use once said battery in the electric vehicle is depleted.

17. A system comprising:
an first energy storage device (ESD), said first energy storage device is configured to increase a mileage of an electric vehicle;
a first power bank, wherein said first power bank is configured to provide backup power to said electric vehicle to increase said mileage of said electric vehicle;
said first power bank comprises one or more batteries connected in series or parallel;
a housing section arranged in said energy storage device, said housing section is configured to generally secure said first power bank in said first energy storage device;
a plurality of tires configured to bestow mobility to said first energy storage device;
a towing or tethering mechanism that is configured to be operable for engaging said first energy storage device to the electric vehicle;
a cable or power cord with power adapter or plug that is configured to electrically couple said electric vehicle to said first energy storage device;
an outlet that is configured to accept said power cord;
a second energy storage device (ESD) that is configured to carry a second power bank, said second energy storage device is operable for easy reconnecting or disconnecting;
a power switch, said power switch is configured to switch to said first or second power bank once said power switch detects depletion of a battery in the electric vehicle; and
a programmable controller coupled to said power switch, wherein said programmable controller is configured to automatically determine which power bank is depleted, energized, and which bank to use once said battery in the electric vehicle is depleted.

18. The system of claim 17, further comprising access handle implements, said access handle implements are configured to enable access to at least one of said first and second power bank for replacement or maintenance without having to swap-out both banks, or without having to swap-out an entire ESD where only the banks are swapped to save time and money.

19. The system of claim 18, further comprising a network component, said network component comprises an antenna and an LED affixed at a top of said antenna, wherein said antenna at least one of, retract and telescope out, and wherein said LED is configured to at least one of, stay on solid and flash, so as to alert, warn, or remind the electric vehicle driver, other drivers, and other surrounding individuals, of the energy storage devices tethered or towed behind.

20. The system of claim 19, a second towing or tethering mechanism that is configured to be operable for engaging said second energy storage device to said first energy storage device, whereby a plurality of energy storage devices may be engaged in a similar way from behind the second energy storage device.
